(19) United States
(12) Patent Application Publication
(10) Pub. No.: US 2005/0051280 A1
(43) Pub. Date: Mar. 10, 2005

(54) Window with variable length screen

(75) Inventors: Bruce E. Thomas, Brookings, SD (US); Kelly D. Nordgaard, Gary, SD (US); Bryan P. Zacher, Brookings, SD (US); Alan M. Dixon, Brookings, SD (US); Allen E. Lee, Brookings, SD (US)

Correspondence Address: Patterson, Thuente, Skaar & Christensen, P.A., 4800 IDS Center, 80 South 8th Street, Minneapolis, MN, 55402-2100, US

(73) Assignee: Larson Manufacturing Company

(21) Appl. No.: 10/952,985

(22) Filed: Sep. 29, 2004

Related U.S. Application Data
(63) Continuation of application No. 10/212,479, filed on Aug. 5, 2002, now abandoned.
(60) Provisional application No. 60/310,557, filed on Aug. 7, 2001.

(51) Int. Cl. E06B 3/32

(52) U.S. Cl. 160/98

(57) ABSTRACT

A window incorporates at least one moving glass insert or sash slidable in first and second spaced apart tracks. An end of the insert or sash is coupled to an end of a spring biased rolled screen. As the insert or sash moves from the roll, the screen is extracted therefrom providing a continuously variable screened region in the window. The insert or sash can be positioned using a counterbalance or spaced apart latchable locations in the window.

### RELATED APPLICATIONS

This application is a continuation of application Ser. No. 10/212,479, filed Aug. 5, 2002 for WINDOW WITH VARIABLE LENGTH SCREEN, by Bruce E. Thomas, Kelly D. Nordgaard, Bryan P. Zacher, Allen M. Dixon and Allen E. Lee, which in turn claims benefit of the earlier filing date of provisional application Ser. No. 60/310,557 filed Aug. 7, 2001, for INSERT OR SASH WITH TIED SCREEN, by Bruce E. Thomas, Kelly d. Nordgaard, Bryan P. Zacher, Alan M. Dixon and Allen E. Lee.

### FIELD OF THE INVENTION

The invention pertains to windows. More particularly, the invention pertains to windows having at least one slidable glass filled sash or panel with an extendable screen attached thereto.

### BACKGROUND OF THE INVENTION

Storm windows which incorporate panes of glass and screens are known. Some forms of such windows include screens which are fixedly mounted to the frame of the windows with sliding sashes or glass inserts. With these windows, the inserts usually can be locked into a plurality of vertical positions with spring loaded latches to expose varying, degrees of screen. When the inserts ate moved to their fully close position, such as during, storms or in cold weather, a person looking at the window, must look through at least one pane of glass and the screen.

In other forms of windows, glass inserts or screen inserts are installed on the windows' frame depending on the season. In warmer weather the glass insert is removed and a screen insert is used in the frame. In cooler weather, the screen is removed and a glass insert is attached to the frame. With such windows, an individual looking at the window looks through either a pane of glass or a screen but not both.

A window configuration is known which includes glass which can be opened or closed to provide ventilation. A spring biased screen module is attached to the window's frame. A horizontally retractable screen which can be manually extended across art open window to exclude insects or other flying pests.

While the known windows are generally suitable for their intended purpose, they all suffer from one or more deficiencies in performance, convenience and ease of use. There continues to be a need for multi-season windows which provide convenient and easy to use screened openings during warmer drier weather while at the same time making it possible to easily close the screened area with a sash or glass pane during cooler or wetter weather. Preferably such windows could be manufactured, at least in part, using techniques for manufacturing existing windows so as to benefit from the economies of scale that such manufacturing capabilities provide. Additionally, it would be preferable if such windows were easy to maintain mid designed to be forgiving in the event that the screen is in need of replacement.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1A is a front elevational view of a door;

FIG. 1B is a top plan view of the door of FIG. 1A;

FIG. 1C is a side view of the door of FIG. 1A;

FIG. 2A is a rear elevational view of the door of FIG. 1A;

FIG. 2B is a rear elevational view of an alternate door;

FIG. 3A is an exploded view of the door of FIG. 1A;

FIG. 3B is a rear isometric view of the door of FIG. 1A;

FIG. 4A is an exploded view of an alternate embodiment of the door of FIG. 1A;

FIG. 4B is a rear isometric view of the door of FIG. 4A;

FIGS. 5A and B are side sectional views taken along plane 5A-5A of the door of FIG. 1A;

FIG. 5C is a sectional view taken along plane 5C-5C of the door of FIG. 1A;

FIG. 5D is an enlargement of a portion of the section of FIG. 5C;

FIG. 5E is a sectional view taken along plane 5E-5E of FIG. 5A;

FIG. 5F is an enlarged partial view of a portion of the door of FIG. 1A illustrating details thereof;

FIG. 5G is an enlarged partial view illustrating details of an alternate embodiment of the door of FIG. 1A;

FIGS. 6A, 6B and 6C taken together are isometric views illustrating a process of engaging an extendable screen cloth with the jambs of the door of FIG. 1A;

FIGS. 7A-7C illustrate details of a replaceable screen module usable in the door of FIG. 1A;

FIG. 8 is a rear isometric view of the door of FIG. 1A illustrating aspects of removing and replacing the screen module;

FIG. 9 is an enlarged region of a portion of FIG. 8 illustrating additional details thereof;

FIG. 10 is a front elevational view of another door;

FIG. 10A is a side section of the door of FIG. 10 taken along plane 10A-10A;

FIG. 11 illustrates an end sectional view of a plurality of alternate mechanisms for coupling a retractable screen to a movable door insert;

FIG. 12A is a rear elevational view of another door;

FIG. 121 is a top view of the door of FIG. 12A;

FIG. 13A is a front elevational view of a closed window in accordance with the invention having horizontal or side slidable sashes;

FIG. 13B is a top plan view, in section, taken along plane 133B-13B of the window of FIG. 13A;

FIG. 14A is a front elevational view of the window of FIG. 13A in an open state,

FIG. 14B is a sectional view taken plane 14B-14B of FIG. 14A;

FIG. 15A is a front elevational view of a closed window having vertically movable sashes;

FIG. 15B is a side sectional view taken along plane 1513-15D of FIG. 15A;

FIG. 16A is a front elevational view of the window of FIG. 15A in an open state; and

FIG. 16B is a side sectional view of the window of FIG. 16A taken along plane 16B-16B.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

In one embodiment of the invention, an exterior door incorporates a replaceable screen module which includes an integral, spring biased, retractable screen which is coupled to a movable glass insert in the door. As the insert is moved from the screen, the screen is withdrawn from its retracted position and extends along the frame of the door screening the otherwise open region from which the glass insert has moved. As the window sash or insert moves in the opposite direction toward the screen module, the screen is retracted into the module reducing the ventilation region available in the door.

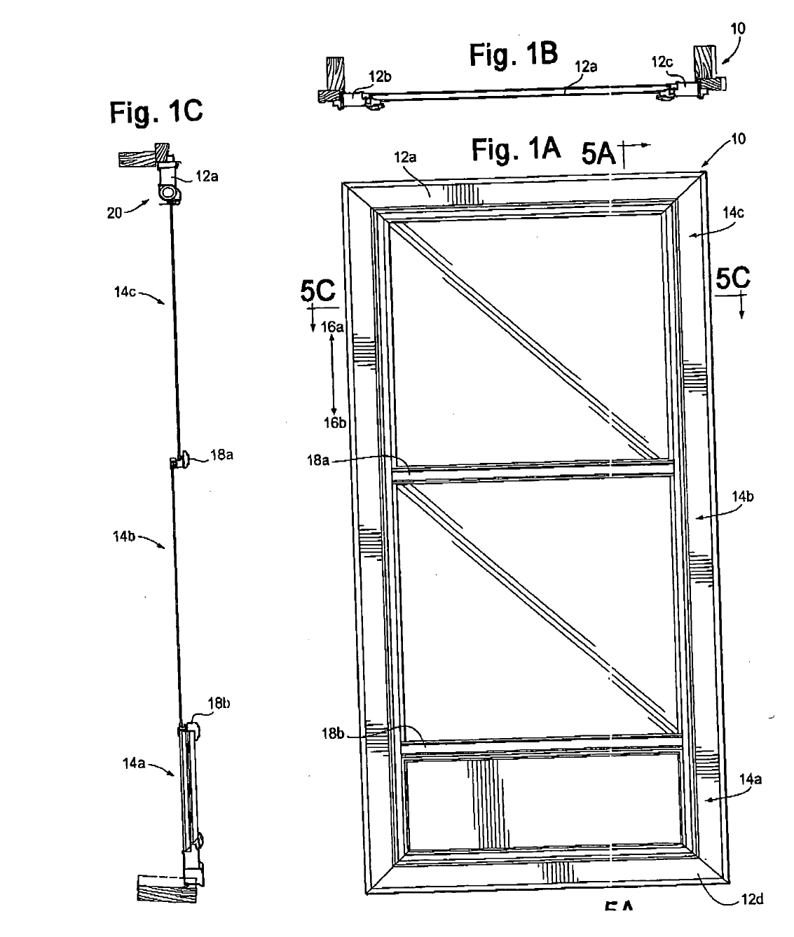

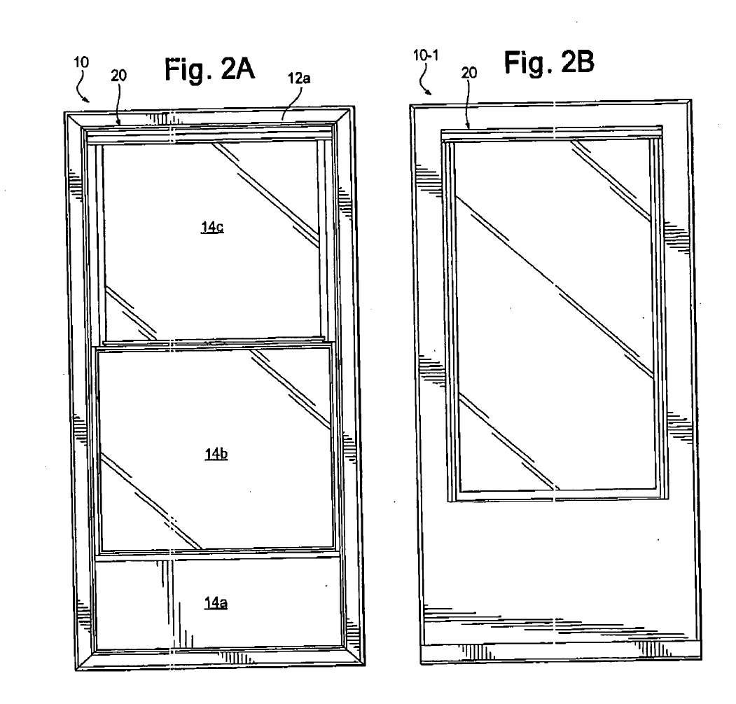

FIGS. 1A-1C illustrate various views of a door 10 which embodies the present invention. The door 10 includes a header 12a, two door jambs 12b, c and a sill 12d. The members 12a . . . d define a door frame with an interior region which in the door 10 includes a kick plate generally indicated at 14a, a lower pane or glass insert 14b, and an upper pane or glass insert 14c. Mullions 18a, b on 111e exterior side of the frame join jambs 12b, c.

In the door 10, the pane or insert 14b is fixedly mounted between the jambs 12b, c and above the kick plate 14a The pane or insert 14c is mounted in tracks, discussed in more detail subsequently, for vertical motion generally in directions 16a, b relatively to insert 14b.

When the insert 14c is positioned at its uppermost location adjacent to header 12a, the door 10 is fully closed with two glass panes as one would use it in cool or wet weather. The pane or insert 14c can be moved, vertically, in direction 16b, away from header 12a thereby opening the upper portion of door 10 for ventilation.

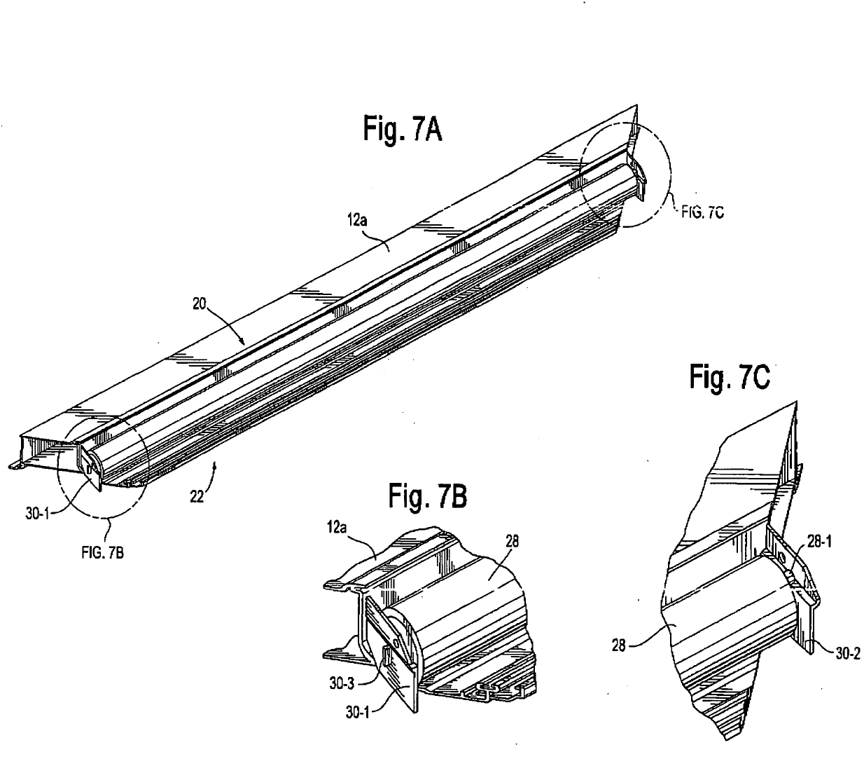

A screen module 20, best seen in FIG. 7A can be coupled to the jambs; 12b, c, header 12a or sill 12d. Module 20 carries a retracted screen which has a free end which carries an attachment member 22 which is coupled to an upper end of insert 14c. As the insert 14c is moved in the direction 16b, screen fabric or material 22-1 from the module 20 is extracted therefrom filling any gap or space between an upper end of insert 14c and header 12a.

Door 10 can thus, as described above, be converted from a storm door with two glass panes to a screen door simply by moving pane or insert 14c vertically downwardly. Where insert 14c is moved vertically downwardly to kick plate 14a, the extracted screen fills the entire area previously closed by pane 14c.

When the insert 14c is raised, direction 16a, the screen material 22-1 retracts into module 20 for storage. As discussed below, module 20 is removable for maintenance or replacement.

It will be understood that alternate configurations to the door 10 come within the spirit and scope of the present invention. For example, the screen module 20 can be mounted at or near the base 12d to provide an openable lower screened region. Alternately, instead of screening material, sheet plastic could be used in the module 20.

Members 12a-12d of the frame for the door 10 can be formed of metal, such as extruded aluminum, extruded or molded plastic, or partly or completely of a wood product. Inserts 14b, c need not include glass but could in fact be closed with translucent or transparent plastic material without departing from the spirit and scope of the present invention.

FIG. 2A is a rear elevational view of the door 10 illustrating the location of screen module 20 adjacent to header 12a. Screen module 20 is enclosed by a removable cover 24 which can be removed for purposes of maintenance and for replacing the module 20.

FIG. 2B illustrates an alternate embodiment, a wood core door 10-1 which incorporates screen module 20. The wood core door 10-1 can be formed with a wood-products core covered with either metal, such as aluminum, or cured resin such as vinyl. It will be understood that the screen module 20 is coupled to a sash or insert, comparable to the insert 14c, which moves vertically in tracks, as would be understood by those of skill, in the frame for the door 10-1.

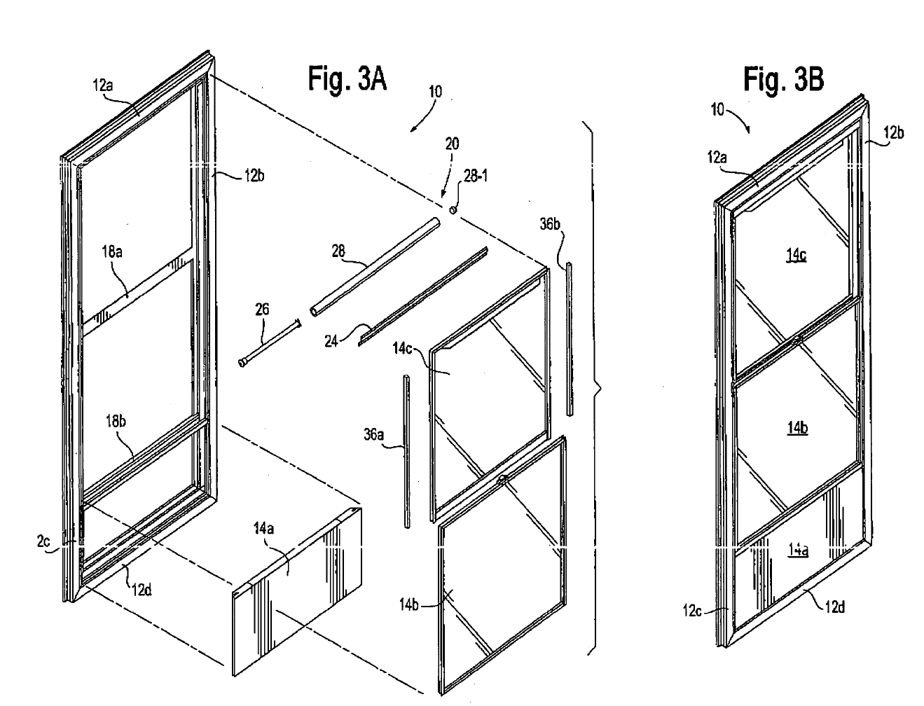

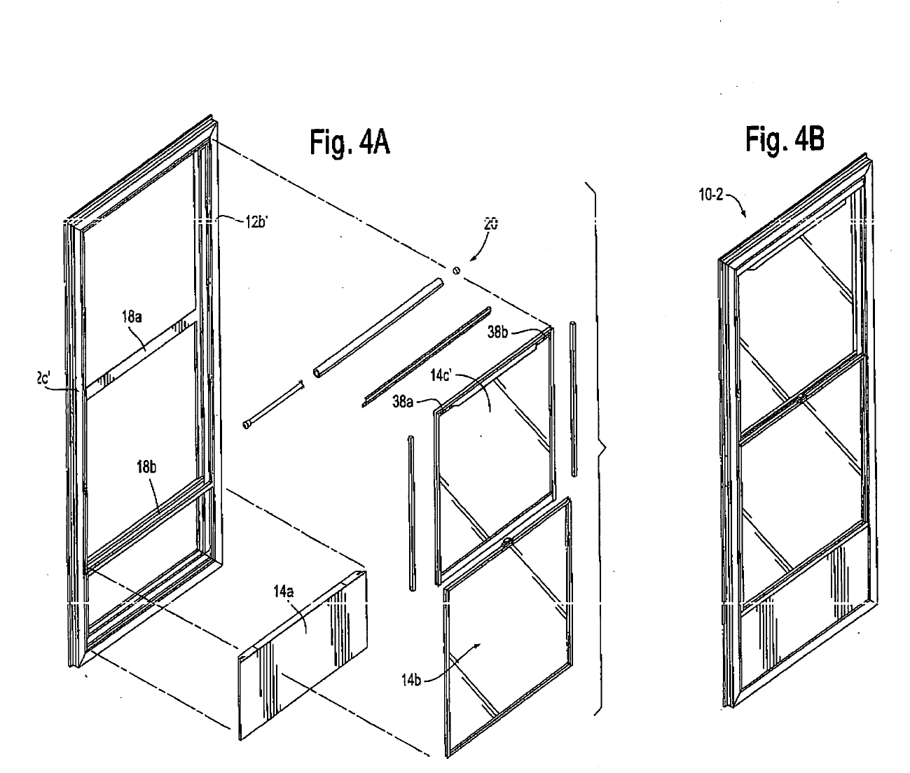

FIGS. 3A and 3B are an exploded view of the door 10 and a rear isometric view thereof.

As illustrated in FIG. 3A, module 20 incorporates a spring or retractor assembly 26 which is carried in a hollow screen roll or cylinder 28. The cylinder 28 rotates about retractor assembly 26 and pivot cap 28-1.

The module 20 is attached to the door so as to permit rotary motion thereof by brackets 30-1 and 30-2, best seen in FIGS. 7A-C. Screen roll 28 carries the coiled screen fabric 22-1 with attached connection member 22, best seen in FIG. 7B.

The spring assembly 26 exerts a substantially constant retracting force on the spring fabric on the roll 28 as the insert 14c is moved vertically in directions 16a, b. The screen material 22-1 is thus constantly under tension.

The insert 14c in door 10, is counterbalanced by counterbalancing mechanisms 36a, b carried by the insert 12a. The counterbalancing mechanisms 36a, b move with the insert 14a in the jambs 12b, c and are invisible to the user. Types of counterbalances include block and tackle balance, spiral balance and coil spring balance

The counterbalances 36a, b make it possible to smoothly move the insert 14c in the direction 16a, b. The insert 14c can be positioned anywhere along its range of travel and will remain there until moved due to the forces exerted by the counterbalance mechanisms 36a, b.

FIGS. 4A, B illustrate an alternate embodiment, a door 102, which embodies the present invention. Those elements of door 10-2 which correspond to previously discussed elements of the door 10 have been assigned the same identification numerals. As an alternate to the counterbalance mechanisms 36a, b, the door 102 incorporates spring biased finger operable latches 38a, b which are carried by the insert 14c′. The latches extend laterally outwardly into slots in the jambs 12b′, c′ to lock the insert 14c′ into a plurality of spaced apart vertical positions.

In the door 12, the insert 14c′ can be moved vertically to a locking position, the movement will retract the screen 22-1 off of the roll 28 and filling the area of the door frame from which the insert 14c′ has been moved. The mechanical latches 38a, b will lock the insert 14c′ at the desired degree of openness in the frame of the door 10-2 desired.

In yet another embodiment, insert 14c can frictionally engage tracks in jambs 23b, c. The frictional forces will support insert 14c at any one of a variety of positions. In this embodiment, no counterbalances ir latches are needed.

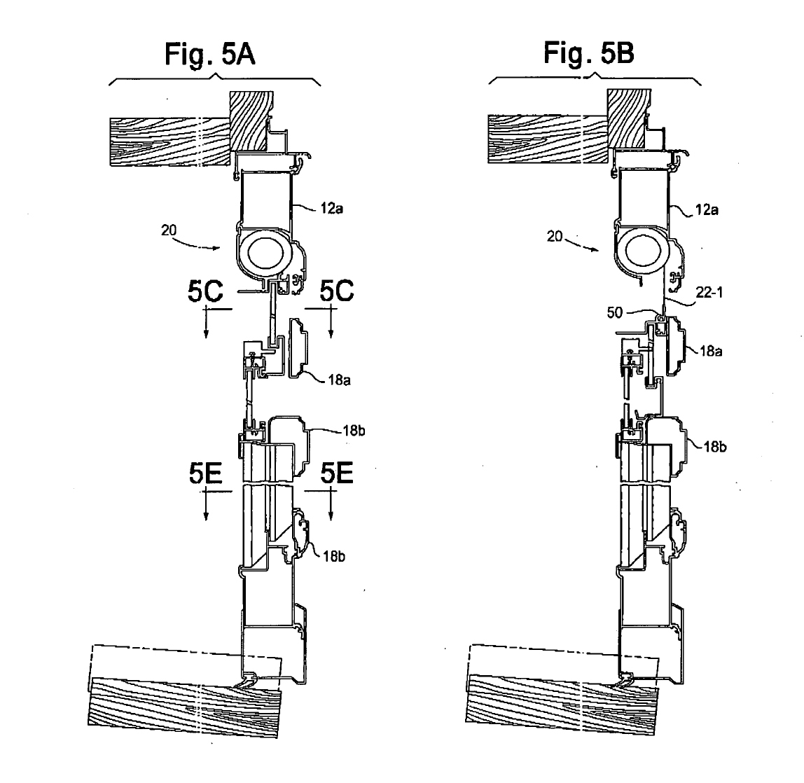

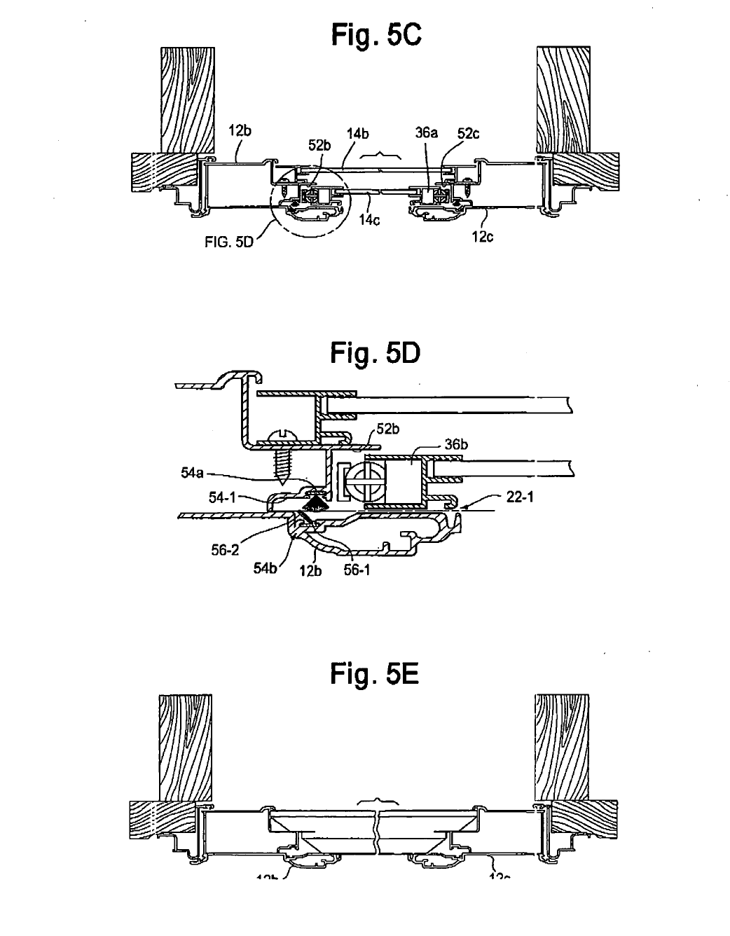

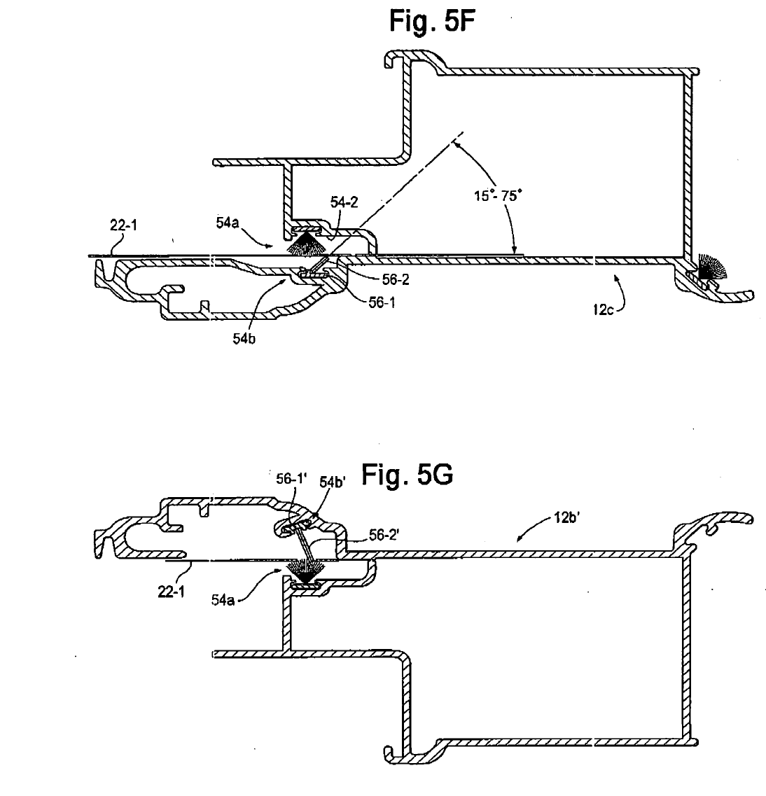

FIGS. 5A and 5B are sectional views taken along plane 5A-5A of FIG. 1A. The views of FIGS. 5A, B illustrate the relationship of various structural elements of the door 10 as the insert 140 moves from a fully closed position, FIG. 5A, to a partially open position, FIG. 5B. FIG. 5B illustrates the extended screen fabric 22-1.

FIG. 5C, a section taken along plane 5C-5C of FIG. 1A illustrates the insert tracks 52b, 52c which run axially along each of the jambs 12b, C. The insert 14c moves axially in and is retained within those tracks.

As illustrated in FIG. 5B, the insert 14c which is coupled to the screen fabric 22-1 moves axially in tracks 52b, c between insert 14b and mullion 18a. The screen end retaining member 22 is slidably received in a retaining feature 50 located at an upper end of the insert 14c.

Edges of the screen fabric 22-1 are confined in axial tracks 54-1, -2. These can be formed in jambs 12b, c.

FIG. 5D illustrates the counterbalance mechanism 36a, b which is carried by the insert 14c. Hence, insert 14c can be located at any vertical position on its range of travel as defined by the tracks 52b, 52c along the jambs 12b, c. When so positioned, the screen fabric 22-1, will be extended from the module 20 to the connector feature 50 to close the opening in the fine of the door 10 left by moving the insert 14c to a position closer to the kick plate 14 at.

FIG. 5D also illustrates the screen material 22-1, illustrated in phantoms extended, as in FIG. 5B, extending between first and second weather stripping elements 54a and 54b. Weather stripping element 54a extends axially along the respective jamb 12b, c on each side of the door 10. The weather shipping 54a can be any form of weather stripping as would be known to those of skill in the art.

The weather stripping 54b is different and unlike the weather stripping 54a. The weather stripping 54b is also positioned in an axially oriented slot which runs along the jambs 12b, c.

Weather shipping 54b is commercially available from Reddiplex Group PLC, Worchestershire, England under the trade name “MESHLOCK” and is formed with a mounting section 561 which slidably engages the respective slot in the jamb 12b, c. The mounting section 56-1 carries a deflectable planar element 56-2 which extends from the mounting section 56-1 toward the weather shipping 54a at a predetermined angle in a range of 15-75° relative to the plane of the screen.

The weather stripping 54a acts to press the edge of the screen material 22-1 toward the MESHLOCK-type weather stripping 54b, see FIG. 5F. This interaction provides a screen edge retention function. The fibers of the MESHLOCK weather stripping 54b resist screen material 22-1 being pulled from between weather stripping 54a, b, and the tracks 54-1, -2.

It will be understood that other commercially available forms of weather stripping can be used instead of the MESHLOCK brand without departing from the spirit and scope of the invention.

It will be understood that while the MESHLOCK weather strip 54b has been illustrated in FIGS. 5D and 5F as exhibiting an acute angle between the mounting section 56-1 and the screen retaining section 5(5-2, other variations of MESHLOCK weather stripping could be used. Alternately as in FIG. 5C, the members 56-1′, -2′ could be oriented at 90° to one another. In this embodiment, the track in which the mounting section 56-1′ would be located would be oriented at an appropriate angle, best seen in FIG. 5G, relative to the respective jamb 12b, c to provide the desired interaction of pressing the screen material 22-1 between the weather stripping 54a, 54b′.

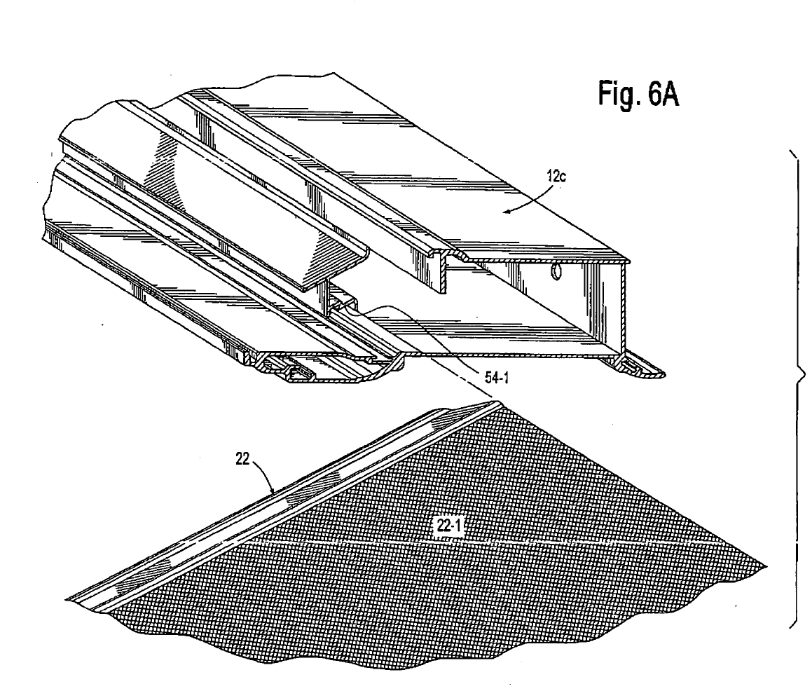

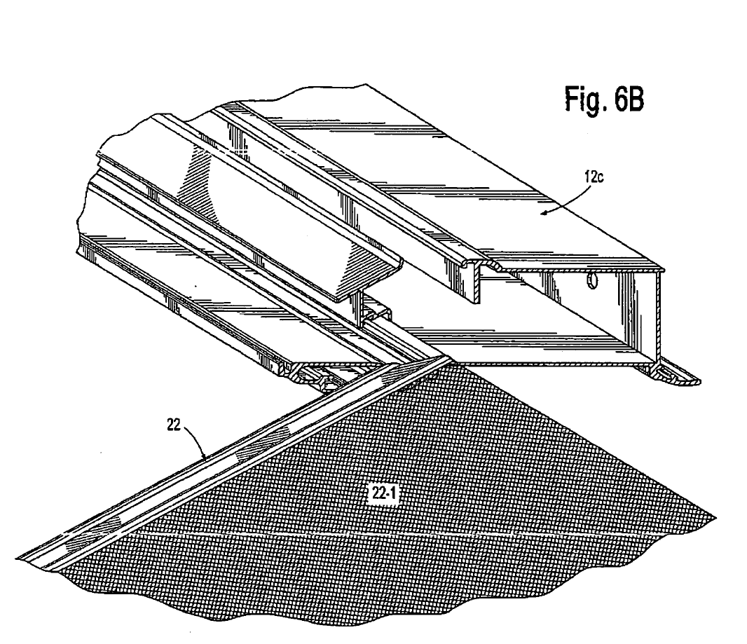

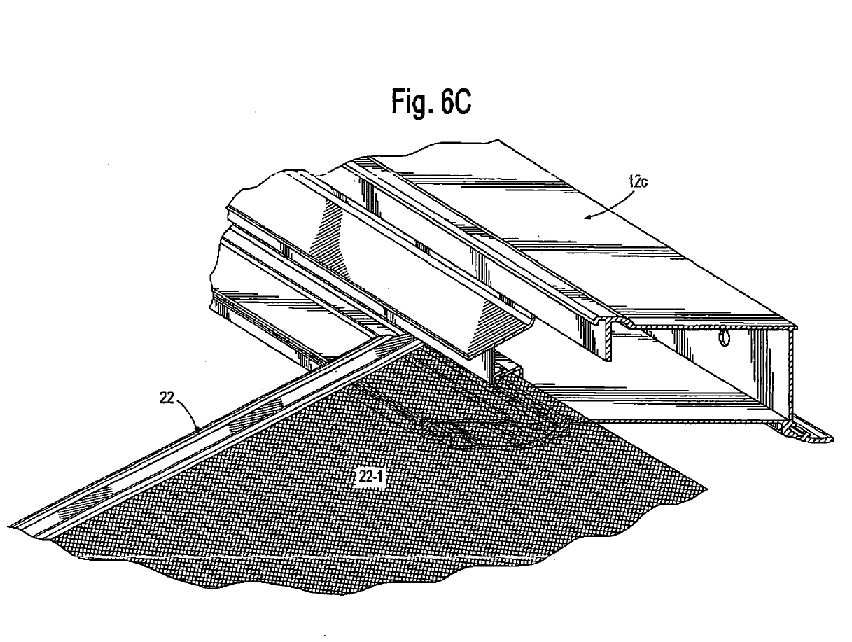

FIGS. 6A, B and C taken together illustrate screen fabric or cloth 22-1 slidably engaging track 54-1, similarly 542, located in each of the jambs 12b, c and which extend axially along the jamb. The end attachment feature 22 also slidably engages the track or slot 54-1, -2 on each of the jambs 12b, c.

Though the screen cloth or material 22-1 may be forced out of the respective tracks 54-1, -2 in each of jambs by a laterally directed force, the screen attachment member 22 will continue to remain in each of the tracks. This is facilitated by the shape of the attachment member 22 which includes an end region 23 which extends into the respective slot 54-1, -2.

In this instance, assuming that the screen cloth 22-1 has been forced from the respective track 541, the upper insert 14c can be moved to its fully closed position adjacent to header 12a to retract the screen onto the screen roll 28. In this circumstance, the attachment feature 22 is properly aligned to se-enter the tracks 54-1. As the insert 14ac is moved away from the header 12a, it will pull the attachment member 22 with it. The ends 23 of the attachment member 22 will enter the respective slots 541 pulling the screen cloth 22-1 with them, and retracking the screen. Alternately, the attachment member 22 can exhibit a retracted condition, adjacent to the screen module 20 while continuing to remain in the tracks 54-1.

Thus, as described above, if a force is exerted against the screen material 22-1 to pull it out of the side tacks 54-1 in each jamb, it is only necessary to reclose the insert 14c to rewind the screen material 22-1 into a proper configuration so that it will be immediately re-extendable into the slots or tracks 54-1.

FIGS. 7A, 7B and 7C illustrate additional details of the screen module 20. The module 20 is supported adjacent to the header 12a by brackets 30-1, -2. Module 20 can be removably attached to the header, the sill or the jambs. The module 20 is removable from the brackets 30-1, -2 for maintenance and/or replacement once the cover 24 has been removed from the respective door.

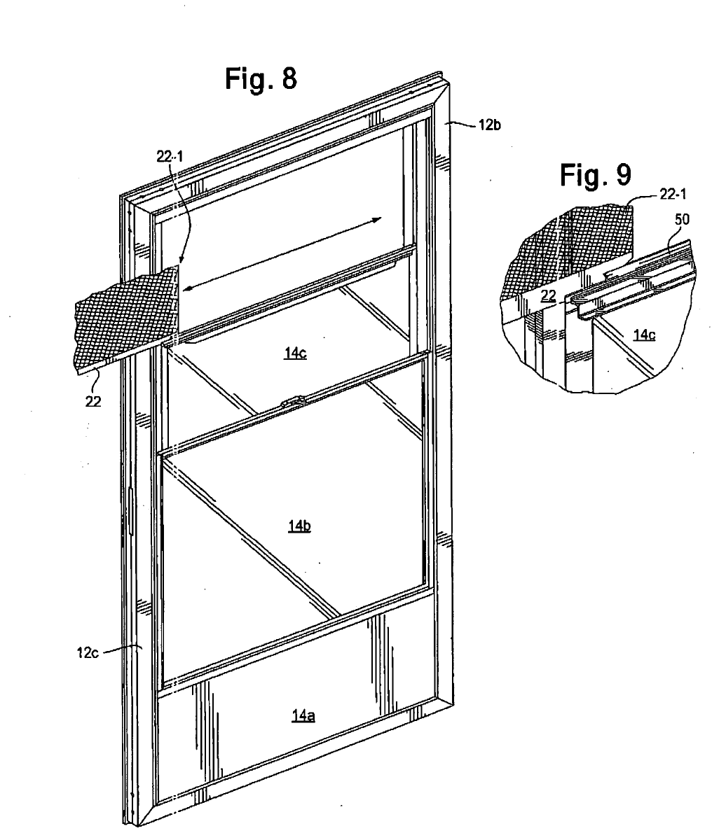

FIG. 8 illustrates additional details of removing and replacing the module 20. The connecting member 22 can be slid from the retaining feature 50 of the insert 14c as illustrated in FIGS. 8 and 9. When so-slid from the retaining feature 50, the entire module 20 can be replaced. Replacement involves attaching the connecting member of the new module to the attachment feature 50 by reversing the process illustrated in FIGS. 8 and 9. The screen roll 28 and screen fabric 22-1 can then be reattached brackets such as brackets 30-1, -2 in the header of the respective door. The cover 24 can be replaced. Moving the insert 14c vertically toward and away from the header will cause the screen fabric 22-1 of the replacement module to retract and extend as expected.

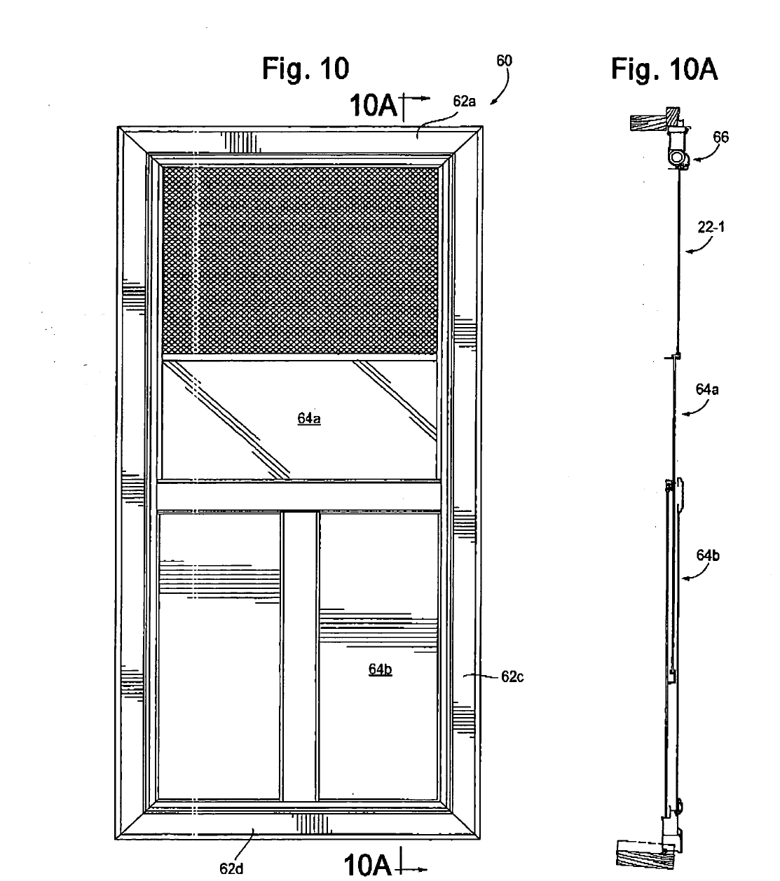

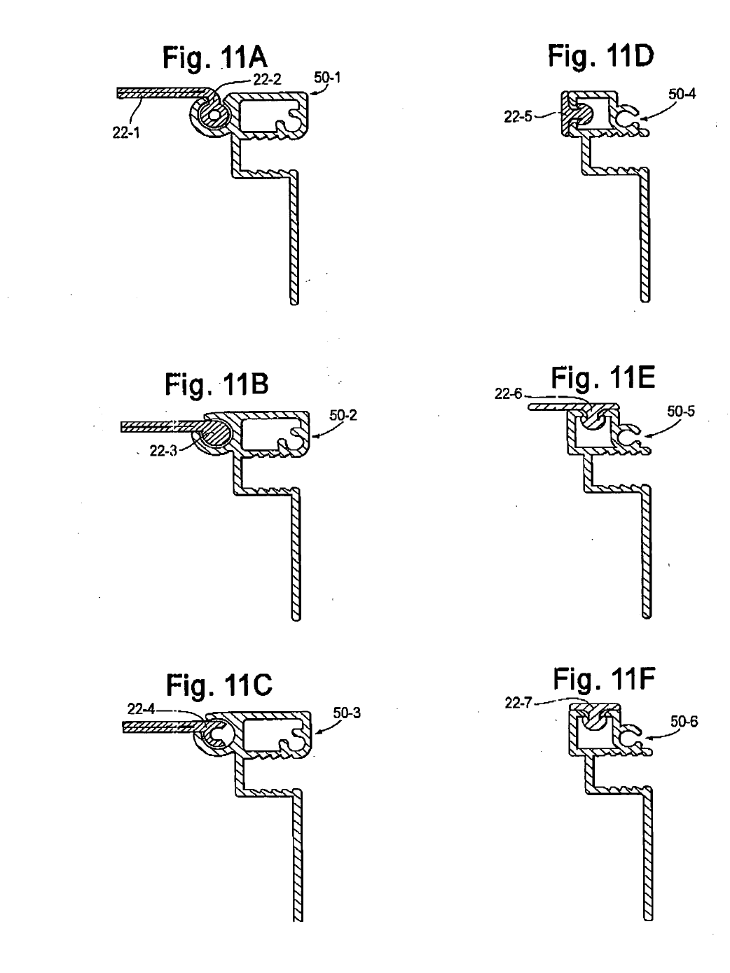

FIGS. 10, 10A and 10R illustrate a door 60 which has a header 62a, jambs 62b, c and a sill 62d. The door 60 includes insert 64a which is movable vertically toward the header 62a and away therefrom toward the sill 62d. The insert 64a can be supported by counterbalances, latches or frictional forces as, discussed above relative to the door 10.

The door 60 carries a screen module 66, best illustrated in FIG. 10A A free end of the screen of the screen module 66 is coupled to an upper end of insert 64a as discussed above.

A lower panel 64b of the door 60 is hollow and contains a space into which the insert 64a can be stored as it is moved downwardly toward the sill 62d. In this configuration, where the insert 64a is partly open, a portion of the screen 66a extends from the screen module 66 and fills the open space between jambs 62b,c and header 62a The remainder of the space between the jambs 62b, c is filled by a portion of the insert 64a and the panel 64b. Thus, the door 60 provides convenient out of sight storage for the insert 64a.

FIG. 11 illustrates a plurality of alternate coupling members 50-1 . . . 50-6 that could be carried on the movable insert or pane, such as the insert 14c, and couplable to a free end of the screen fabric 22-1. As illustrated in FIG. 11, in each instance, the free end of the screen 22-1 would include a coupling element, such as 22-2 . . . 22-7 which would slidably engage the respective coupling member 50-1 . . . 50-6.

It will be understood that other arrangements can be used to attach a free end of the screen member 22-1 to a moving insert or pane. Alternates or include a spline which would trap the free end of the screen fabric 22-1 in contact with the movable inserts such as 14c clamps or adhesives. Other variations come within the spirit and scope of the invention.

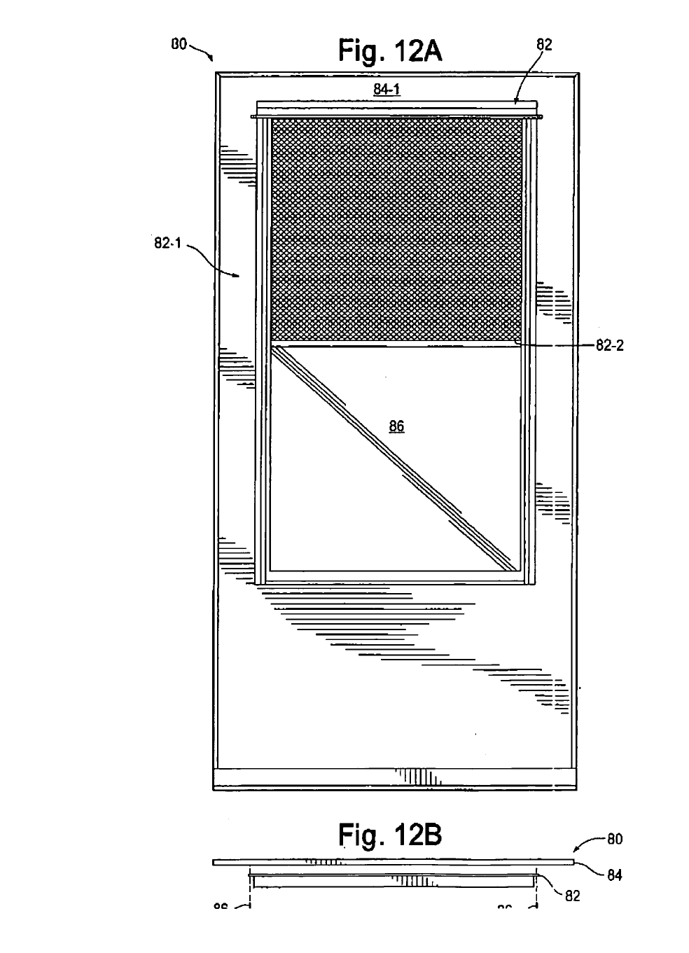

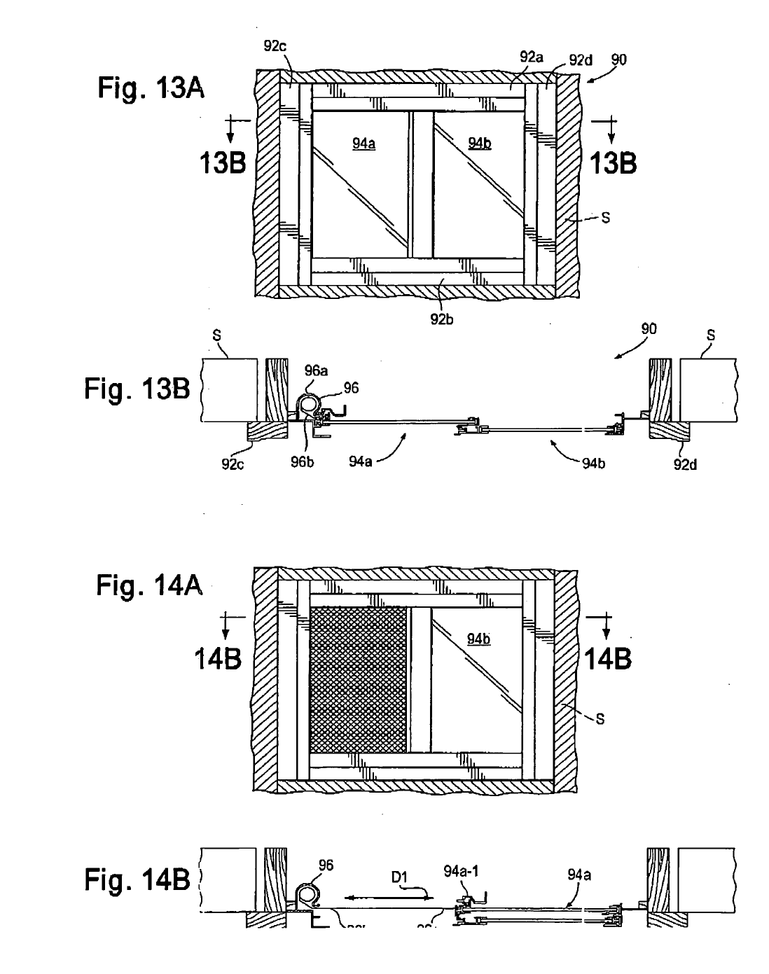

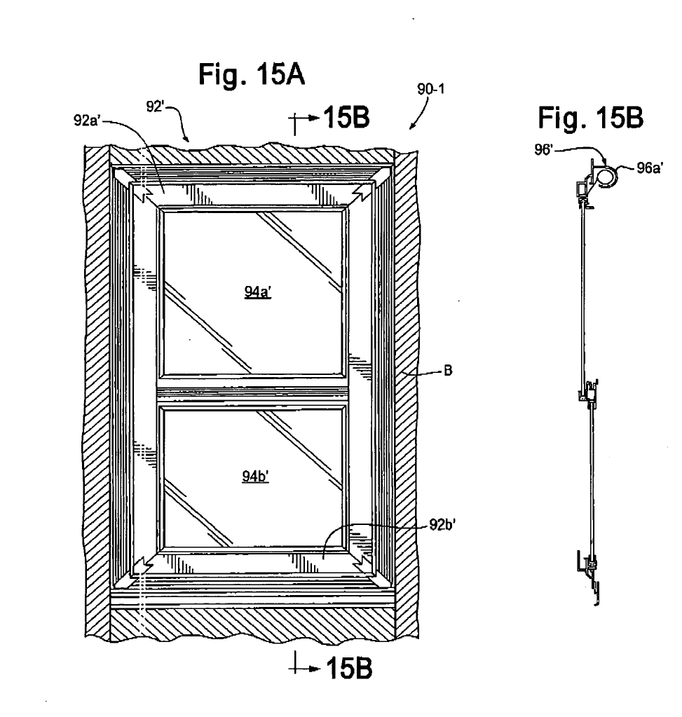

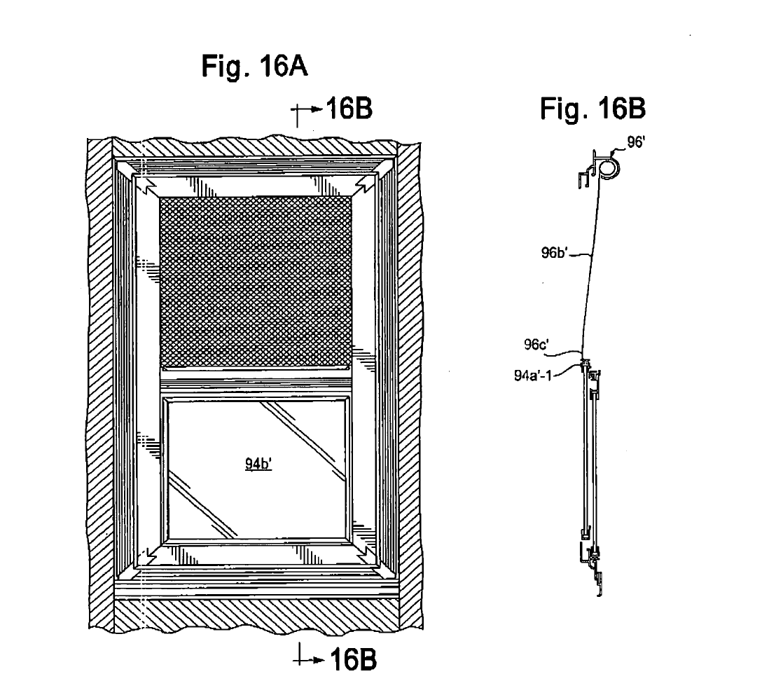

FIG. 12 illustrates a door 80 which incorporates a screen module 82, of the type discussed previously, which can be attached to door 84 as an after the fact accessory or add-on. The module screen 82 can be attached to the door 84 by fasteners 86 in the vicinity of the header 841 of the door.

The screen fabric 82-1 can be pulled from the module 82 to close an opening in the door created by moving insert 86 downwardly away from the module 82. A free end 82-2 of the screen material 82-1 is attached to the sash or insert 86. Attachment can be effected by any of the previously discussed methods including using a spline, adhesive, providing attachment clips which slidably engage a portion of the sash of the insert 86. Other attachment vehicles can be used to connect the free end 82-2 to an upper end of the insert or sash 86 without departing from the spirit and scope of the present invention.

As the sash or insert 86 is moved toward the screen module 82, the fabric 82-1 rollably retracts into the module 82 as a result of the internal spring mechanism, discussed above, in connection with door 10. The screen material 82-1, also as discussed above, is under a constant pulling force due to the spring biasing mechanism of the module 82 which continually attempts to retract the fabric 82-1 into the module 82. Thus, as the sash or insert 86 moves toward the module 82, the screen material 82-1 is immediately rolled into the module 82 for out of the way storage.

It will also be understood that a resin or plastic sheet could be used as an alternate to screen fabric 82-1 without departing from the spirit and scope of the present invention. Thus, the screen module 82 provides a mechanism for adding to any existing door, after installation, a retractable screen feature such that existing screen panels or inserts in the door can be removed. This improves convenience and visibility in that with the sash or insert 86 closed, the screen fabric 82-1 is completely retracted and an individual looking at the door looks directly through the glass inserts or sashes without having to look through a screen.

FIG. 13A is front elevational view of a closed, side sliding window 90 installed in a structure S. The window 90 is bounded by a frame 92 having an elongated lop and bottom 92a, 92b joined by two sides 92c, d. The window 90 incorporates first and second sashes 94a, b of which 94a is movable generally horizontally behind sash 94b, best seen in FIG. 14B.

As illustrated in FIGS. 13B and 14B, the window 90 incorporates a screen module 96 which is attached to the interior side of window 90 adjacent to side 92c. The module 96 is comparable to the module 20 discussed previously.

The module 96 includes a housing 96a which is mechanically attached to or adjacent to the side 92c. The module 96 incorporates a biasing element, for example a spring, to continuously retract a length of screen fabric 96b onto a cylinder, comparable to the cylinder 28, within the housing 96a.

A free end 96c is attached to an adjacent end 94a-1 of the sash 94a As the sash 94a is moved in a direction DI away from the module 96, the screen fabric 96b is drawn therefrom, under continuous tension, to close the opening in the frame of the window 90, best seen in FIG. 14A.

It will be understood that the free end 96c can be connected to the end 94a-1 of the sash 94a using any of the previously discussed structures including splines, clips, clamps, adhesives as well as the various coupling members discussed previously.

As the sash 94a is moved opposite the direction D1, the screen cloth 96b is retracted into the housing 96 in response to the biasing force provided by the retracting mechanism or spring thereby continuing to exhibit an extended, generally straight, attractive appearance due to the tension of the spring biased mechanism. When the sash 94a returns to its fully closed position, the screen cloth 96b will be fully retracted into the housing 96, illustrated in FIG. 13B.

FIGS. 15A, B and 16A, B illustrate a window 90-1 having two vertically movable sashes 94a′ and 94b′. The window 90-1 is installed in and closes an opening in a wall of a building B. One or both of the sashes 94a′, b′ may be movable vertically in the frame 92′.

A screen module 96′ is carried at or adjacent to header 92a′ of the window 901. It could also be mounted adjacent to sill 92b′.

As discussed previously, with respect to window 90, the screen module 96′ includes a housing 96a′ which carries a rotatably mounted roll of screen material 96b′ which is retracted into housing 96a′ by a retracting spring or mechanism carried therein. A free end 96c′ of the screen material is attached to an end 94a′-1 of the sash 94a′.

As the sash 94a′ is moved downwardly from the header 92a′, the screen material 96b′ is extracted from the housing 96a′ closing the opening in the frame 92′ which results from the sash 94a′ moving from its closed position. In this instance, the screen material 96b′ is fed automatically and under tension from the housing 96a′ to a fully extracted position, best seen in FIGS. 16A, B.

When the sash 94a′ is moved upwardly to its closed position, the screen material 96b′ is automatically retracted into the housing 96a′ in response to the biasing roll-up forces exerted by the spring mechanism. The end 96c′ of the screen material can be attached to the sash 94a′ using any of these structures or approaches described above including having coupling members attached to the free end 96c′ and the adjacent end 94a′-1 of the sash, splines, clamps, adhesives or the like, all without limitation. Instead of a screen cloth, such as cloth 96b, 96b′, plastic sheet can be used to fill the open space in the respective window.

It will also be understood that screen tracks and weather stripping, such as tracks 541, -2 and weather stripping 54a, b, can be analogously incorporated into windows 90 and 90-1. If the module 96 or 96′ is incorporated into storm windows, the counterbalances or latches 36a, b or 38a, b could also be used.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A window comprising:
a frame having a header, first and second sides having respective first and second fabric guides and a sill assembled to define an interior region;
a sash configured for slidable movement in the interior region;
an elongated fabric module adapted to carry a retractable fabric, the retractable fabric having first and second fabric edge portions slidably receivable within corresponding of the first and second fabric guides, the retractable fabric being subject to biasing retracting force by the fabric module;
a free end heaving a coupling member disposed on at least a portion thereof that is attachable to a portion of the sash, wherein at least one end portion of the coupling member is slidable within at least one of the first and second fabric guides; and
wherein the retractable fabric is movable toward and away from the module in response to the slidable movement of the sash within the interior region and the first and second fabric edge portions of the retractable fabric are substantially maintained within the first and second fibric guides.

2. A window as in claim 1 with at least one track in each side wherein the sash moves in the tracks with the fabric rollably retracting into the module as the sash moves toward the module and rollably extending from the module as the sash moves away from the module.

3. A window as in claim 1 wherein the module includes a module roller retracting spring.

4. A window as in claim 4 wherein the retracting spring imposes a continuous retracting force on the fabric.

5. A window as in claim 1 wherein at least one of the first and second fabric guides include
at least one section of weather-stripping.

6. A window as in claim 5 which includes first and second different sections of weather stripping.

7. A window as in claim 1 wherein the sash carries a hollow coupling element which slidably receives the coupling member coupled to the fabric.

8. A window as in claim 1 wherein the coupling member is coupled to the sash by at least one of a spline, a clamp, adhesive or a two-part coupling element.

9. A window as in claim 1 wherein the fabric comprises one of a screen, or, a plastic sheet.

10. A window comprising:
a frame;
a sash slidable in the frame and having first and second sash side portions;
a screen module attached to the frame wherein the module includes a biasing element adapted to impose a retracting force on a screen rolled into the module;
first and second spaced apart screen guides adjacent to the sash side portions wherein the screen has first and second edge portions slidably receivable within the first and second screen guides; and
a free end having a coupling member disposed on at least a portion thereof that is attachable to at least a portion of the sash, wherein at least one end portion of the coupling member is slidable within at least one of the first and second screen guides such that as the sash slidably moves within the frame, the first and second edge portions of the screen are substantially maintained within the screen guides.
